(19) United States
(12) Patent Application Publication
(10) Pub. No.: US 2026/0155611 A1
(43) Pub. Date: Jun. 4, 2026

(54) ELECTRIC WIRE WITH TERMINAL AND CONNECTOR

(71) Applicant: YAZAKI CORPORATION, Tokyo (JP)

(72) Inventors: Hideki MIZUNO, Shizuoka (JP); Masanori NAKAMURA, Shizuoka (JP); Shinichi KAMURA, Shizuoka (JP)

(73) Assignee: YAZAKI CORPORATION, Tokyo (JP)

(21) Appl. No.: 19/394,157

(22) Filed: Nov. 19, 2025

(30) Foreign Application Priority Data
Dec. 4, 2024 (JP) 2024-211536

(51) Int. Cl. H01R 13/66; H01R 13/05

(52) U.S. Cl. CPC H01R 13/6683; H01R 13/052

(57) ABSTRACT

An electric wire with a terminal includes: a terminal; an electric wire having a conductor core wire connected to the terminal; a first tube covering a periphery of a contact point between the terminal and the conductor core wire; a temperature sensor disposed so as to be in contact with the first tube and configured to measure a temperature of the terminal; and a second tube covering the temperature sensor.

### CROSS-REFERENCE TO RELATED APPLICATION(S)

This application is based upon and claims the benefit of priority from prior Japanese patent application No. 2024-211536 filed on December 4, 2024, the entire contents of which are incorporated herein by reference.

### BACKGROUND

### 1. Field of the Invention

The present disclosure relates to an electric wire with a terminal in which an electric wire is connected to a terminal, and a connector including the electric wire with a terminal.

### 2. Description of the Related Art

In the related art, in order to supply (charge) electric power from the outside of a vehicle to a battery mounted on a vehicle such as an electric automatic vehicle or a plug-in hybrid automatic vehicle, a connector for charging installed in the vehicle has been proposed (for example, see JP2023-131545A). This type of connector is generally called a charging inlet.

The connector (charging inlet) described above is generally required to have structures and characteristics defined by various standards. For example, since a temperature (so-called operating temperature) of the terminal increases due to Joule heat generated in the terminal during energization, a regulation value related to a temperature change or the like of the terminal may be defined by a standard. Actually, in the connector of the related art described above, the operating temperature of the terminal is measured using a thermistor. However, in the connector of the related art described above, the thermistor is disposed at a position away from the terminal using a metal holder, and heat is transferred from the terminal to the thermistor via the holder. When heat is transferred through such a path, it takes time to transfer heat from the terminal to the holder depending on a size of a contact area between the terminal as a heat source and the holder, and as a result, it may take time to detect the temperature by the thermistor. From a viewpoint of improving a temperature measurement performance of the thermistor, the time required for temperature detection is desirably as short as possible.

### SUMMARY

An object of the present disclosure is to provide a electric wire with a terminal and a connector having an excellent temperature measurement performance by a temperature sensor.

To achieve the above object, the electric wire with a terminal and the connector according to the present disclosure has the following features.

According to an aspect of the present disclosure, there is provided an electric wire with a terminal including: a terminal; an electric wire having a conductor core wire connected to the terminal; a first tube covering a periphery of a contact point between the terminal and the conductor core wire; a temperature sensor disposed so as to be in contact with the first tube and configured to measure a temperature of the terminal; and a second tube covering the temperature sensor.

According to another aspect of the present disclosure, there is provided a connector including: the electric wire with a terminal according to the above, and a housing accommodating the terminal of the electric wire with a terminal.

According to the electric wire with a terminal and the connector of the present disclosure, the first tube (for example, the heat shrinkable tube) covers the periphery of the contact point between the conductor core wire of the electric wire and the terminal, and the temperature sensor is disposed so as to be in contact with the first tube. Further, the second tube covers the temperature sensor. As a result, heat generated from the contact point where particularly large Joule heat can be generated due to a contact resistance between the terminal and the conductor core wire is quickly transferred to the temperature sensor via the first tube disposed so as to cover the contact point (that is, with a large contact area with respect to the contact point). Therefore, time required for temperature detection by the temperature sensor can be shortened as compared with the connector of the related art described above. Further, since the second tube covers the temperature sensor, the state in which the temperature sensor is in contact with the first tube is appropriately maintained. Therefore, the electric wire with a terminal and the connector of the present disclosure are excellent in temperature measurement performance by the temperature sensor.

The present disclosure is briefly described above. Further, details of the present disclosure will be clarified by reading modes for carrying out the invention described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view illustrating a state in which an electric wire with a terminal and a housing are separated from each other in a connector according to an embodiment of the present disclosure;

FIG. 2 is a perspective view illustrating the electric wire with a terminal illustrated in FIG. 1;

FIG. 3 is an exploded perspective view of the electric wire with a terminal illustrated in FIG. 2;

FIG. 4 is a cross-sectional view taken along a line A-A in FIG. 2; and

FIG. 5 is an enlarged view of a portion B in FIG. 4.

### DETAILED DESCRIPTION OF THE INVENTION

### Embodiment

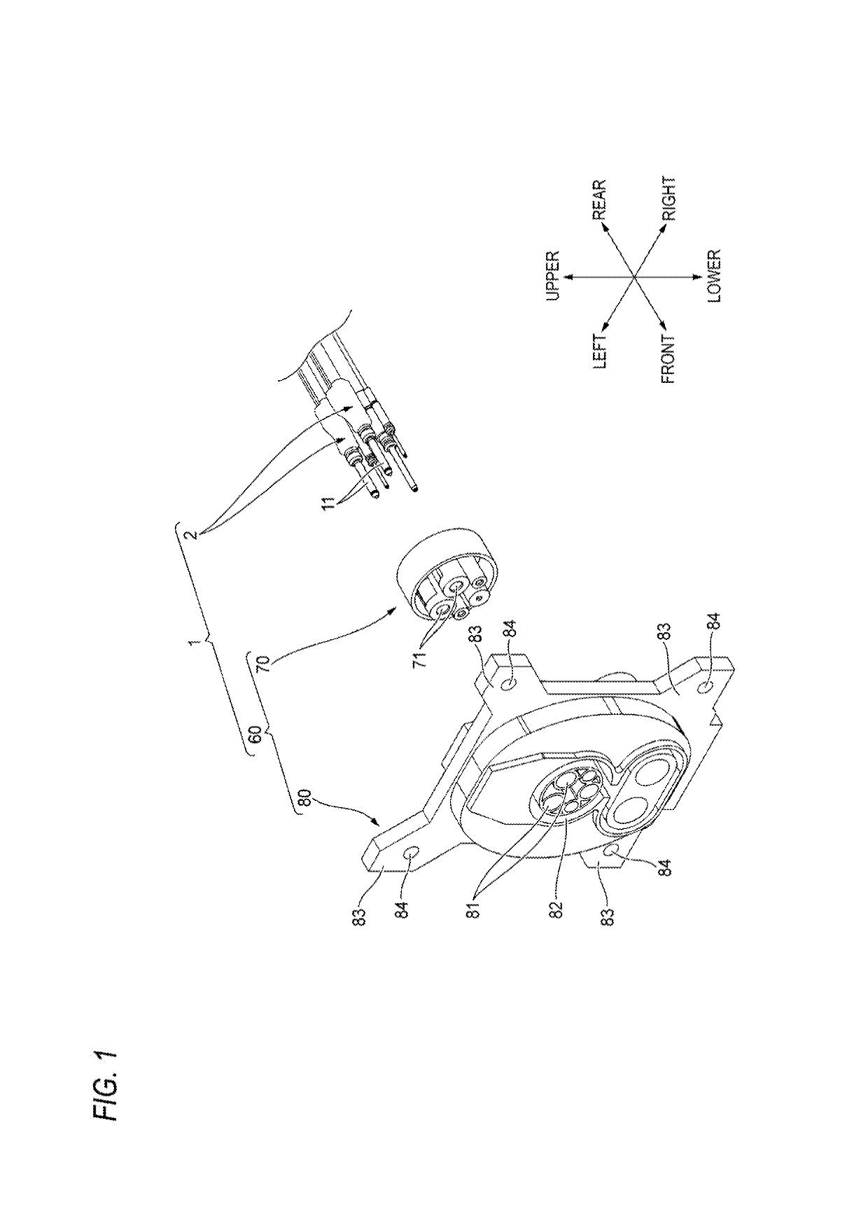

Hereinafter, a connector 1 according to an embodiment of the present disclosure including an electric wire 2 with a terminal according to the embodiment of the present disclosure will be described with reference to the drawings. The connector 1 is a connector that is installed in a vehicle such as a plug-in hybrid automatic vehicle or an electric automatic vehicle, and is connected to an electric wire extending from a battery mounted in the vehicle. The connector 1 is also called a charging inlet. By fitting a counterpart connector (so-called charging gun) into a fitting recessed portion 82 (see FIG. 1) of the connector 1, electric power is supplied to the battery from the outside of the vehicle, and the battery is charged.

Hereinafter, for convenience of description, "front", "rear", "left", "right", "upper", and "lower" are defined as shown in FIG. 1 or the like. A "front-rear direction", a "left-right direction", and an "upper-lower direction" are orthogonal to one another. The front-rear direction corresponds to a fitting direction of the connector 1 and the counterpart connector (not illustrated), and a front side in the fitting direction (a side closer to the counterpart connector) as viewed from the connector 1 is referred to as a "front side", and a release side in the fitting direction (a side away from the counterpart connector) as viewed from the connector 1 is referred to as a "rear side". The "front-rear direction", the "left-right direction" and the "upper-lower direction" are merely defined for convenience of description, and do not necessarily match a front-rear direction, a left-right direction and an upper-lower direction of the vehicle when the connector 1 is mounted on the vehicle.

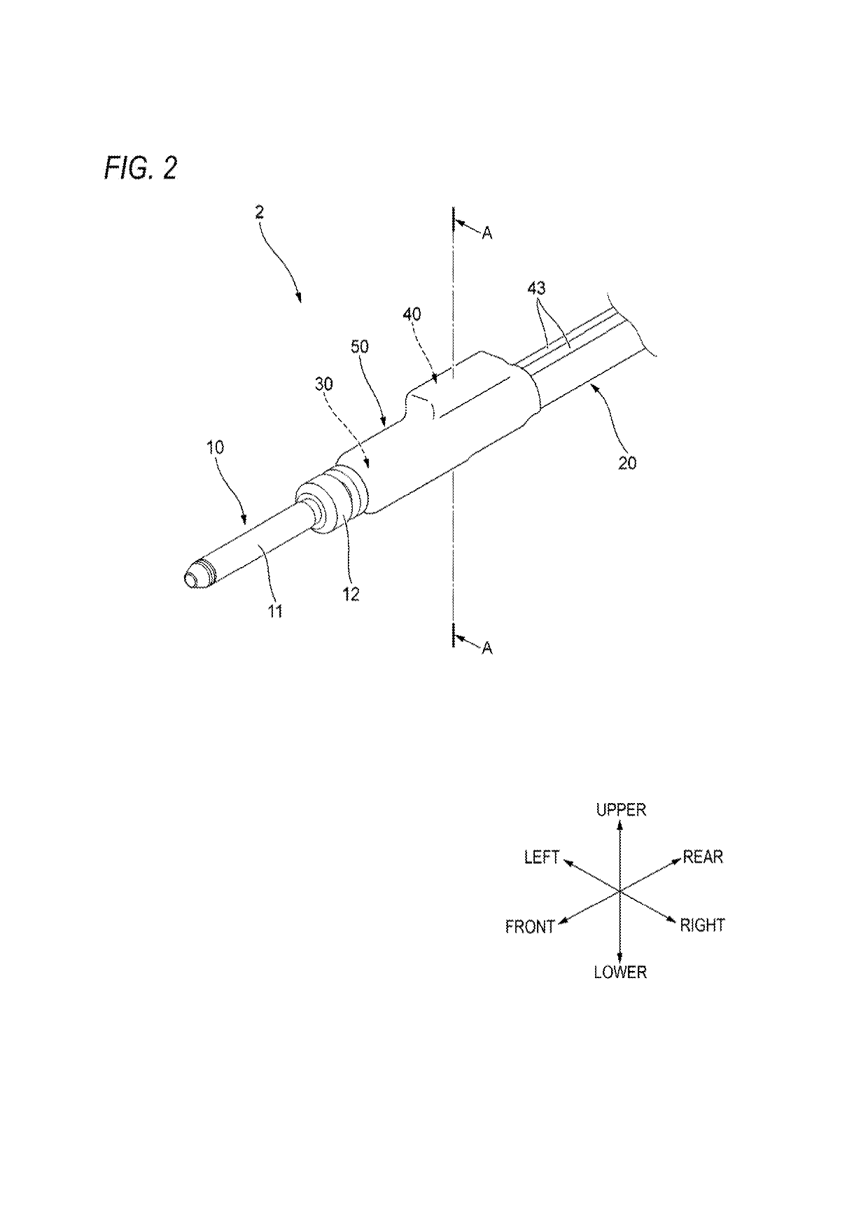

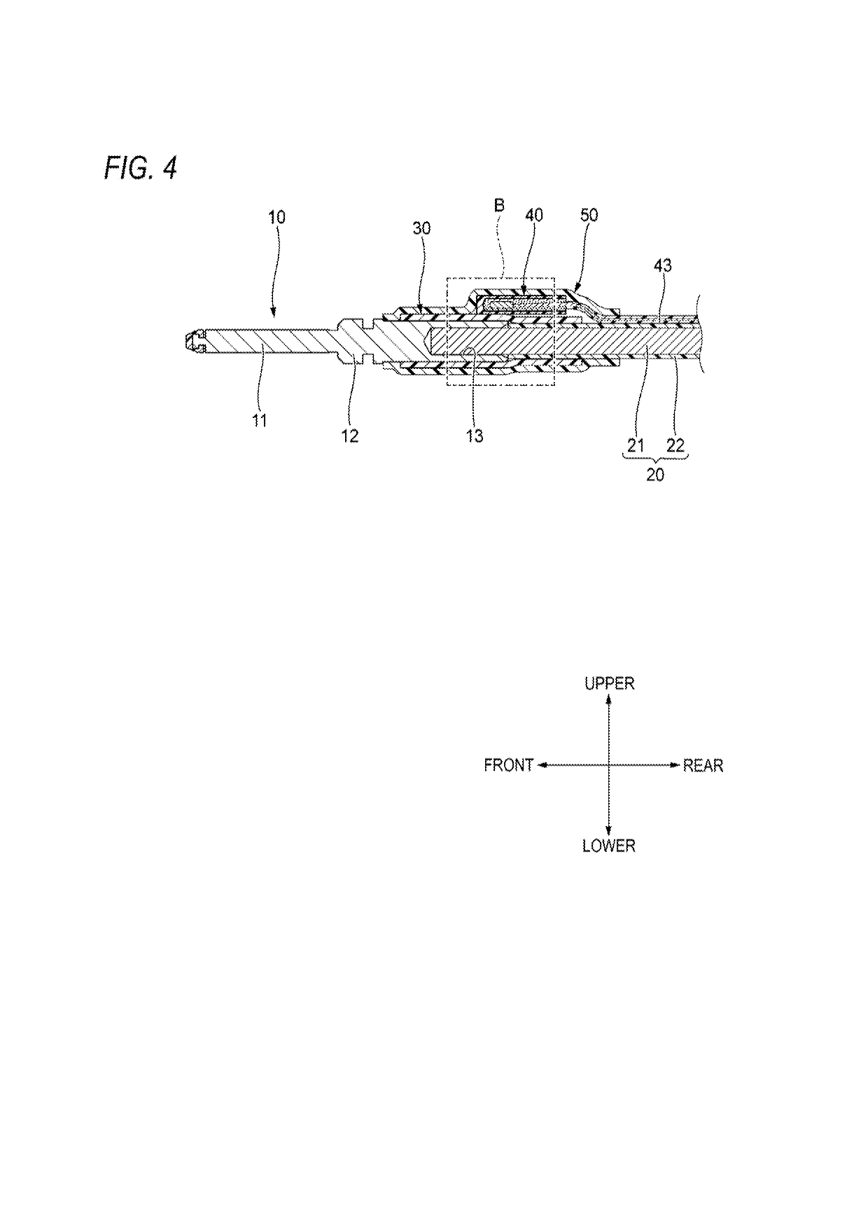

As illustrated in FIG. 1, the connector 1 includes a plurality of (two in this example) electric wires 2 with a terminal and a housing 60 that accommodates terminals 10 (see FIGS. 2, 4 and the like) of the electric wires 2 with a terminal. Hereinafter, the electric wire 2 with a terminal and the housing 60 constituting the connector 1 will be described in order.

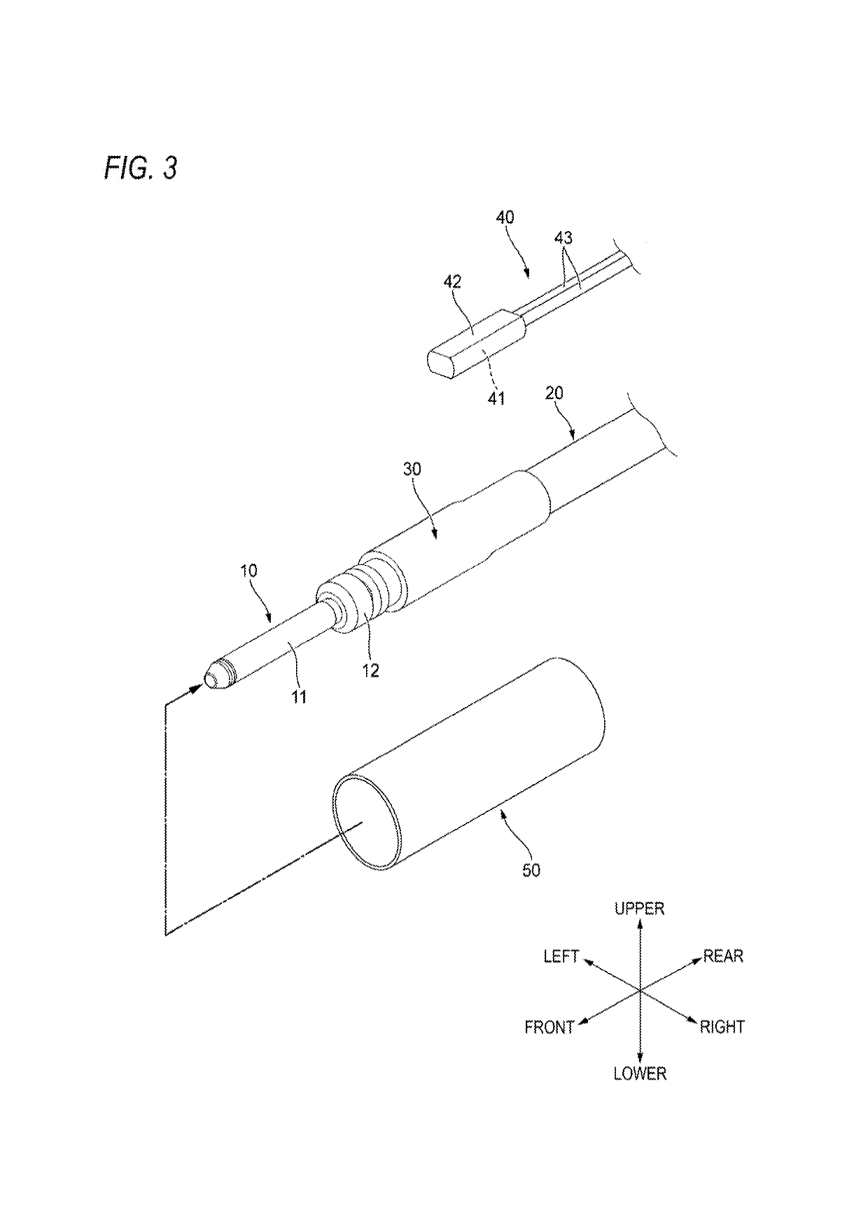

First, the electric wire 2 with a terminal will be described. As illustrated in FIGS. 2, 3, and the like, the electric wire 2 with a terminal includes the terminal 10, an electric wire 20 connected to the terminal 10, a heat shrinkable tube 30 that covers a periphery of a contact point between the terminal 10 and a conductor core wire 21 of the electric wire 20, a temperature sensor 40 that is disposed so as to be in contact with the heat shrinkable tube 30 and can measure a temperature of the terminal 10, and a heat shrinkable tube 50 that covers the temperature sensor 40. The electric wire 20 includes the conductor core wire 21 and a sheath 22 made of an insulating resin and covering the conductor core wire 21 (see FIG. 4).

The terminal 10 is made of metal and, as illustrated in FIGS. 3 and 4, is a male terminal having a stepped cylindrical shape extending in the front-rear direction, including a small-diameter portion 11 and a large-diameter portion 12 positioned behind the small-diameter portion 11. When the connector 1 is fitted to the counterpart connector, the small-diameter portion 11 of the terminal 10 is connected to a counterpart terminal (a female terminal, not illustrated) included in the counterpart connector.

A cylindrical recessed portion 13 recessed forward is formed in a rear end surface of the large-diameter portion 12 (see FIG. 4). The conductor core wire 21 exposed at one end portion of the electric wire 20 is inserted into the recessed portion 13 and is fixed by crimping. Thus, the terminal 10 and the electric wire 20 are electrically connected. A contact portion between an inner peripheral side surface of the recessed portion 13 of the large-diameter portion 12 and an outer peripheral surface of the one end portion of the conductor core wire 21 constitutes a "contact point" between the terminal 10 and the conductor core wire 21. The other end portion of the electric wire 20 is connected to a battery (not illustrated).

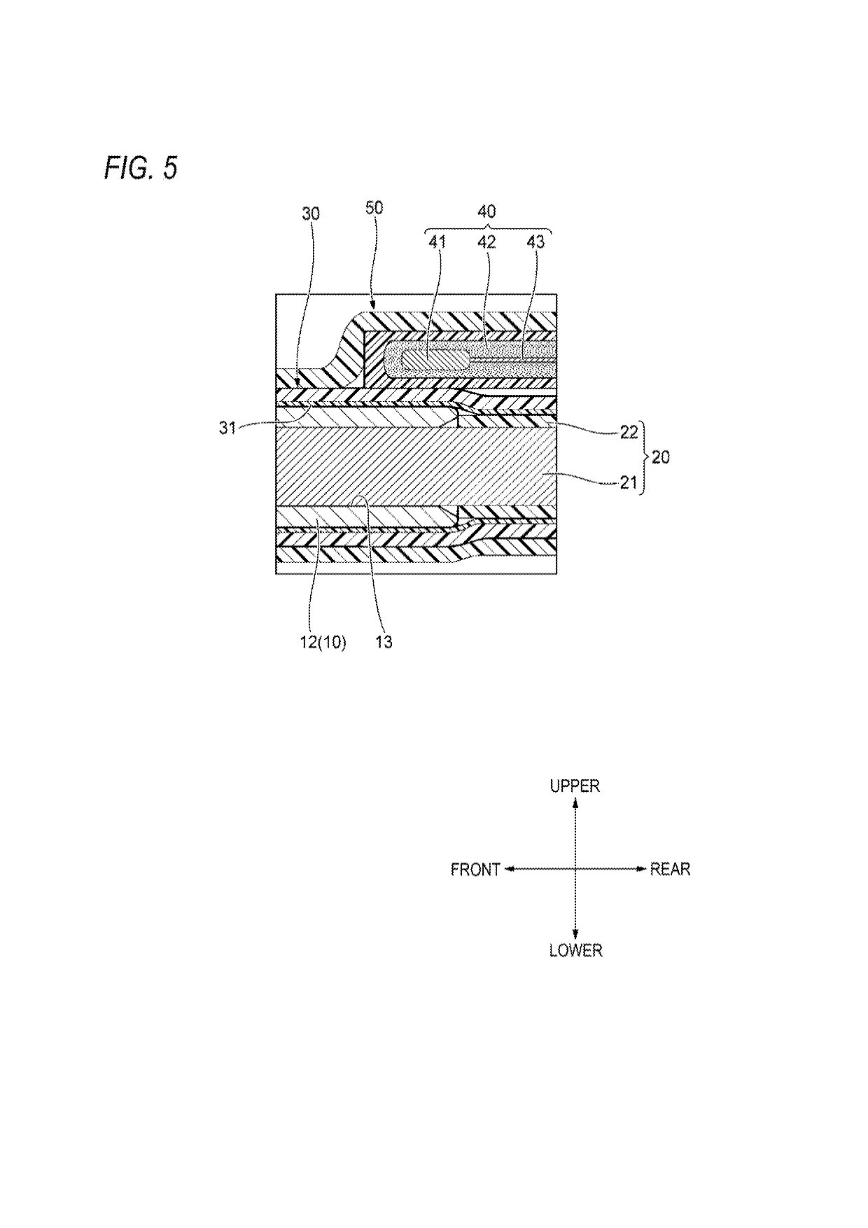

An outer diameter of the large-diameter portion 12 is substantially equal to an outer diameter of the sheath 22 of the electric wire 20. The heat shrinkable tube 30 made of a resin is attached to a connection portion between the terminal 10 and the electric wire 20 so as to collectively adhere to and cover an outer peripheral surface of the large-diameter portion 12 and an outer peripheral surface of one end portion of the sheath 22 of the electric wire 20. The heat shrinkable tube 30 is a cylindrical tube made of a resin such as polyolefin or fluoropolymer. The heat shrinkable tube 30 has an adhesive layer 31 made of a resin adhesive on a cylinder inner surface (see FIG. 5).

The heat shrinkable tube 30 shrinks by being heated in a state of being attached so as to cover the connection portion between the terminal 10 and the electric wire 20. Then, the shrunk heat shrinkable tube 30 collectively adheres to and covers the outer peripheral surface of the large-diameter portion 12 of the terminal 10 and the outer peripheral surface of the one end portion of the sheath 22 of the electric wire 20. The heat shrinkable tube 30 is disposed in this manner (see FIGS. 3 and 4). As a result, the adhesive layer 31 included in the cylinder inner surface of the heat shrinkable tube 30 is in close contact with the terminal 10 and the electric wire 20 so as to cover the periphery of the "contact point" between the terminal 10 and the conductor core wire 21, and thus water is appropriately prevented from entering the "contact point" between the terminal 10 and the conductor core wire 21 from the outside. Further, the state in which the heat shrinkable tube 30 is in close contact with the terminal 10 and the electric wire 20 is firmly maintained by the adhesive layer 31.

The temperature sensor 40 functions to measure the temperature of the terminal 10. The temperature sensor 40 is a thermistor that functions as a contact-type temperature sensor, and specifically, as illustrated in FIGS. 4 and 5, includes a thermistor element 41 and a body portion 42 in which the thermistor element 41 is incorporated. Since the thermistor element 41 has excellent temperature measurement accuracy and a high resistance to an external force such as vibration, the thermistor element 41 can be suitably used for measuring the temperature of the terminal 10 of the electric wire 2 with a terminal. In this example, the body portion 42 has a substantially rectangular parallelepiped shape extending in the front-rear direction. A pair of electric wires 43 connected to the thermistor element 41 extends from a rear end of the body portion 42.

The temperature sensor 40 is disposed such that the body portion 42 is in direct contact with the outer peripheral surface of the heat shrinkable tube 30 attached to the connection portion between the terminal 10 and the electric wire 20, and the pair of electric wires 43 extending rearward from the body portion 42 extend along the outer peripheral surface of the electric wire 20 extending from a rear end of the heat shrinkable tube 30. Then, the heat shrinkable tube 50 made of a resin is attached so as to collectively adhere to and cover the heat shrinkable tube 30 and the body portion 42 of the temperature sensor 40 disposed on the outer peripheral surface of the heat shrinkable tube 30 (see FIGS. 2 to 4). Like the heat shrinkable tube 30, the heat shrinkable tube 50 is a cylindrical tube made of a resin such as polyolefin or fluoropolymer. Unlike the heat shrinkable tube 30, the heat shrinkable tube 50 does not have an adhesive layer made of an adhesive on a cylinder inner surface in view of the fact that it is less necessary to provide a waterproof function for the "contact point" between the terminal 10 and the conductor core wire 21. As a result, a manufacturing cost of the electric wire 2 with a terminal can be reduced.

The heat shrinkable tube 50 is heated in a state of being attached so as to collectively cover the heat shrinkable tube 30 and the body portion 42 of the temperature sensor 40 disposed on the outer peripheral surface of the heat shrinkable tube 30, so that the heat shrinkable tube 50 itself shrinks and is disposed so as to collectively adhere to and cover the heat shrinkable tube 30 and the body portion 42 of the temperature sensor 40. As a result, the body portion 42 of the temperature sensor 40 is fixed to the outer peripheral surface of the heat shrinkable tube 30, and a state in which the body portion 42 is in direct contact with the outer peripheral surface of the heat shrinkable tube 30 is appropriately maintained (see FIGS. 4 and 5), whereby the heat of the terminal 10 is quickly transferred to the thermistor element 41 of the temperature sensor 40 via the heat shrinkable tube 30. Therefore, the electric wire 2 with a terminal has an excellent temperature measurement performance by the temperature sensor 40. Hereinafter, the electric wire 2 with a terminal will be described.

The terminal 10 of the electric wire 2 with a terminal having the above configuration is accommodated in the housing 60. First, the housing 60 will be described.

As illustrated in FIG. 1, the housing 60 includes a base holder 70 and a housing body 80. Each of the base holder 70 and the housing body 80 is a frame component of the housing 60 and constitutes a part of an outer surface of the housing 60.

First, the base holder 70 will be described. The base holder 70 is a resin molded product, and has a function of holding the terminals 10 of the pair of left and right electric wires 2 with a terminal in a state of being insulated from each other at an interval in the left-right direction. As illustrated in FIG. 1, the base holder 70 is formed with a pair of left and right terminal accommodating chambers 71 extending in the front-rear direction. When the terminals 10 of the pair of left and right electric wires 2 with a terminal are accommodated in the pair of left and right terminal accommodating chambers 71 from the rear side, the terminals 10 of the pair of left and right electric wires 2 with a terminal are held by the base holder 70.

Next, the housing body 80 will be described. The housing body 80 is a resin molded product and is assembled to the base holder 70 from a front side. As illustrated in FIG. 1, the housing body 80 is provided with a pair of left and right cylindrical terminal accommodating portions 81 protruding forward corresponding to the pair of left and right terminals 10. Each of the terminal accommodating portions 81 is positioned in the fitting recessed portion 82 and has an internal space penetrating in the front-rear direction. By assembling the housing body 80 to the base holder 70, the terminals 10 of the pair of left and right electric wires 2 with a terminal are respectively accommodated in the pair of left and right terminal accommodating portions 81 of the housing body 80. The housing body 80 is provided with a flange portion 83 extending in the left-right direction and the upper-lower direction. The flange portion 83 is fastened and fixed to an attachment target portion (not illustrated) of the connector 1 provided in the vehicle by using bolts (not illustrated) inserted into a plurality of bolt insertion holes 84 provided in the flange portion 83, so that the entire housing 60 (the base holder 70 and the housing body 80) is fixed to the attachment target portion. The housing 60 has been described above.

### Operations and Effects

As described above, according to the electric wire 2 with a terminal and the connector 1 according to the present embodiment, a first tube (the heat shrinkable tube 30) covers the periphery of the contact point between the conductor core wire 21 of the electric wire 20 and the terminal 10, and the temperature sensor 40 is disposed so as to be in contact with the first tube. Further, a second tube (the heat shrinkable tube 50) covers the temperature sensor 40. As a result, the heat generated from the contact point where particularly large Joule heat can be generated due to a contact resistance between the terminal 10 and the conductor core wire 21 is quickly transferred to the temperature sensor 40 via the first tube 30 disposed so as to cover the contact point (that is, with a large contact area with respect to the contact point). Therefore, time required for temperature detection by the temperature sensor 40 can be shortened as compared with the connector of the related art described above. Further, since the second tube 50 covers the temperature sensor 40, a state in which the temperature sensor 40 is in contact with the first tube 30 is appropriately maintained. Therefore, the electric wire 2 with a terminal and the connector 1 having this configuration are excellent in temperature measurement performance by the temperature sensor 40.

According to the electric wire 2 with a terminal of the present embodiment, the adhesive layer 31 included in the cylinder inner surface of the first tube 30 is in close contact with the terminal 10 or the electric wire 20, so that a state where the first tube 30 is in close contact with the contact point is firmly maintained. Further, water is appropriately prevented from entering the contact point between the terminal 10 and the conductor core wire 21 of the electric wire 20 from the outside. In addition, since the second tube 50 that is not essential for waterproofing the contact point does not have an adhesive layer, the manufacturing cost of the electric wire 2 with a terminal can be reduced.

According to the electric wire 2 with a terminal of the present embodiment, the thermistor (the thermistor element 41) is used as the temperature sensor 40. Since the thermistor (the thermistor element 41) has the excellent temperature measurement accuracy and a high resistance to an external force such as vibration, the thermistor can be suitably used for temperature measurement of the terminal 10 in the electric wire 2 with a terminal.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

Here, features of the embodiment of the electric wire 2 with a terminal and the connector 1 according to the present disclosure described above are briefly summarized and listed in [1] to [4] below.

1 An electric wire (2) with a terminal including: a terminal (10); an electric wire (20) having a conductor core wire (21) connected to the terminal (10); a first tube (30) covering a periphery of a contact point between the terminal (10) and the conductor core wire (21); a temperature sensor (40) disposed so as to be in contact with the first tube (30) and configured to measure a temperature of the terminal (10); and a second tube (50) covering the temperature sensor (40).

According to the electric wire with a terminal having the above configuration [1], the first tube (for example, the heat shrinkable tube) covers the periphery of the contact point between the conductor core wire of the electric wire and the terminal, and the temperature sensor is disposed so as to be in contact with the first tube. Further, the second tube covers the temperature sensor. As a result, the heat generated from the contact point where particularly large Joule heat can be generated due to the contact resistance between the terminal and the conductor core wire is quickly transferred to the temperature sensor via the first tube disposed so as to cover the contact point (that is, with a large contact area with respect to the contact point). Therefore, time required for temperature detection by the temperature sensor can be shortened as compared with the connector of the related art described above. Further, since the second tube covers the temperature sensor, a state in which the temperature sensor is in contact with the first tube is appropriately maintained. Therefore, the electric wire with a terminal having this configuration is excellent in temperature measurement performance by the temperature sensor.

2 In the electric wire (2) with a terminal according to [1], the first tube (30) has an adhesive layer (31) made of an adhesive on a cylinder inner surface, and the second tube (50) does not have the adhesive layer (31) on a cylinder inner surface.

According to the electric wire with a terminal having the above configuration [2], the adhesive layer included in the cylinder inner surface of the first tube is in close contact with the terminal or the electric wire, so that a state where the first tube is in close contact with the contact point is firmly maintained. Further, water is appropriately prevented from entering the contact point between the terminal and the conductor core wire of the electric wire from the outside. In addition, since the second tube that is not essential for waterproofing the contact point does not have an adhesive layer, the manufacturing cost of the electric wire with a terminal can be reduced.

3 In the electric wire (2) with a terminal according to [1], the temperature sensor (40) is a thermistor (41).

According to the electric wire with a terminal having the above configuration [3], the thermistor is used as the temperature sensor. Since the thermistor has excellent temperature measurement accuracy and a high resistance to an external force such as vibration, the thermistor can be suitably used for measuring the temperature of the terminal of the electric wire with a terminal.

4 A connector (1) including: the electric wire (2) with a terminal according to any one of [1] to [3]; and a housing (60) accommodating the terminal (10) of the electric wire (2) with a terminal.

According to the connector having the above configuration [4], the first tube (for example, the heat shrinkable tube) covers the periphery of the contact point between the conductor core wire of the electric wire and the terminal, and the temperature sensor is disposed so as to be in contact with the first tube. Further, the second tube covers the temperature sensor. As a result, the heat generated from the contact point where particularly large Joule heat can be generated due to the contact resistance between the terminal and the conductor core wire is quickly transferred to the temperature sensor via the first tube disposed so as to cover the contact point (that is, with a large contact area with respect to the contact point). Therefore, the time required for temperature detection by the temperature sensor can be shortened as compared with the connector of the related art described above. Further, since the second tube covers the temperature sensor, the state in which the temperature sensor is in contact with the first tube is appropriately maintained. Therefore, the connector having this configuration is excellent in temperature measurement performance by the temperature sensor.

1. An electric wire with a terminal comprising:
a terminal;
an electric wire having a conductor core wire connected to the terminal;
a first tube covering a periphery of a contact point between the terminal and the conductor core wire;
a temperature sensor disposed so as to be in contact with the first tube and configured to measure a temperature of the terminal; and
a second tube covering the temperature sensor.

2. The electric wire with a terminal according to claim 1, wherein:
the first tube has an adhesive layer made of an adhesive on a cylinder inner surface; and
the second tube does not have the adhesive layer on a cylinder inner surface.

3. The electric wire with a terminal according to claim 1, wherein
the temperature sensor is a thermistor.

4. A connector comprising:
the electric wire with a terminal according to claim 1; and
a housing accommodating the terminal of the electric wire with a terminal.
